(19) United States
(12) Patent Application Publication
(10) Pub. No.: US 2021/0350040 A1
(43) Pub. Date: Nov. 11, 2021

(54) METHOD OF PHYSICAL MODE EXTRACTION FOR ENGINEERING STRUCTURE FLEXIBILITY IDENTIFICATION

(71) Applicant: DALIAN UNIVERSITY OF TECHNOLOGY, Dallan, Liaoning (CN)

(72) Inventors: Tinghua YI, Dalian, Liaoning (CN); Mingsheng XUE, Dalian, Liaoning (CN); Chunxu QU, Dalian, Liaoning (CN); Hongnan LI, Dalian, Liaoning (CN)

(21) Appl. No.: 17/052,748

(22) PCT Filed: Mar. 6, 2020
(86) PCT No.: PCT/CN2020/078139

§ 371 Date: Nov. 3, 2020

(30) Foreign Application Priority Data
Jan. 15, 2020 (CN) 202010042877.2

(51) Int. Cl. G06F 30/13; G06F 30/20

(52) U.S. Cl. CPC G06F 30/13; G06F 2111/08; G06F 30/20

(57) ABSTRACT

The present invention belongs to the technical field of data analysis for structural testing, and relates to a method of the physical mode exaction for flexibility identification of engineering structures. In the present invention combined deterministic-stochastic subspace identification algorithm is first adopted to calculate basic modal parameters and modal scaling factors from state-space models of different orders. Subsequently, the relative scaling factor difference is added as a new modal indicator to the classic stabilization diagram to better clean out the stabilization diagram. And check the correctness of the selection of the stable axis using single-modal frequency-domain similarity index (SFSI) between single-order FRF and measured FRF. Then, further determine the physical modes from the modes in the stable axis using multi-modal frequency-domain similarity index (MFSI) between lower-order superposition FRF and measured FRF. Finally, calculate flexibility matrix using identified modal parameters and predict the displacement of the structure under static load.

### TECHNICAL FIELD

The present invention belongs to the technical field of data analysis for engineering structural testing, and relates to a method of the physical mode exaction for flexibility identification of engineering structures.

### BACKGROUND

Vibration-based structural health monitoring (SHM) technology has attracted widespread attention in civil engineering, which is considered to be one of the most effective ways to improve safety of engineering structures and to realize the long life and sustainable management of structures. In recent decades, engineers have paid more attention to rapid test method for small and medium span bridges, such as impact vibration test. In addition to obtaining bridge basic modal parameters (natural frequency, damping ratio and mode shape), the structure scaling factor can also be obtained through dynamic testing, which can derive the deep parameter (flexibility) of the structure. Combined deterministic-stochastic subspace identification (DSI) algorithm is one of the most effective methods to identify modal parameters. However, a large number of spurious modes are introduced due to overestimated order and noise during subspace identification.

Up to now, many corresponding researches have been done on extracting physical modes and the extraction methods are almost classified into three categories. The first is physical and spurious modes distinguishing methods based on index threshold value. Scionti and Deraemaeker et al. used model reduction theory to improve the pole selection process in subspace identification algorithm. The second is improving the identification algorithms to get a clearer stabilization diagram in order to extract the physical modes. Qu C X et al. combined the moving data diagram and the traditional stabilization diagram to distinguish spurious modes. The third is analysis method of stabilization diagram based on intelligence algorithms. Intelligence algorithm for physical modal extraction mainly refers to modal clustering technology. Ubertini et al. proposed an automated modal identification procedure, belonging to the class of subspace identification techniques and based on the tool of clustering analysis, and applied it to the operational modal analysis of two bridges. Most research on spurious modes elimination in civil engineering is for operational modal analysis with only output data. However, in the impact vibration test, we do experimental modal analysis based on input and output data to obtain flexibility. On the one hand, the acquisition of accurate flexibility depends on the exact basic modal parameters as well as the exact modal scaling factor. On the other hand, the modal scaling factors obtained from experimental modal analysis can help better eliminate spurious modes generated during the subspace identification process. Therefore, it is important to distinguish the physical modes from the spurious modes during the flexibility identification process.

### SUMMARY

The objective of the presented invention is to provide a new mode selection method for engineering structures, which can solve the spurious mode discrimination problem during the flexibility identification process.

The technical solution of the present invention is as follows:

The physical mode exaction method during flexibility identification process is derived. In the first phase, DSI is adopted to calculate basic modal parameters and modal scaling factors from state-space models of different orders. Subsequently, the relative scaling factor difference is added as a new modal indicator to the classic stabilization diagram to better clean out the stabilization diagram. And check the correctness of the selection of the stable axis using single-modal frequency-domain similarity index (SFSI) between single-order FRF and measured FRF. Then, further determine the physical modes from the modes in the stable axis using multi-modal frequency-domain similarity index (MFSI) between lower-order superposition FRF and measured FRF. Finally, calculate flexibility matrix using identified modal parameters and predict the displacement of the structure under static load.

The procedures of the physical mode exaction method for the flexibility identification of engineering structures are as follows:

Step 1: Collect input and output data and calculate modal parameters of different orders;

(1) Built the Hankel matrix, and the measured inputs are grouped into the following block Hankel matrix,

$${U}_{0 \vert 2 v - 1} = [ \begin{matrix}{u}_{0} & {u}_{1} & {u}_{2} & ⋯ & {u}_{w - 1} \\ {u}_{1} & {u}_{2} & {u}_{3} & ⋯ & {u}_{w} \\ ⋯ & ⋯ & ⋯ & ⋯ & ⋯ \\ {u}_{v - 1} & {u}_{v} & {u}_{v + 1} & ⋯ & {u}_{v + w - 2} \\ {u}_{v} & {u}_{v + 1} & {u}_{v + 2} & ⋯ & {u}_{v + w - 1} \\ {u}_{v + 1} & {u}_{v + 2} & {u}_{v + 3} & ⋯ & {u}_{v + w} \\ ⋯ & ⋯ & ⋯ & ⋯ & ⋯ \\ {u}_{2 v - 1} & {u}_{2 v} & {u}_{2 v + 1} & ⋯ & {u}_{2 v + w - 2}\end{matrix} ] = [ \frac{{U}_{0 \vert v - 1}}{{U}_{v \vert 2 v - 1}} ]$$

where U_{0|v-1} and U_{v|2v-1} is the upper and lower parts of the matrix U_{0|2v-1}, respectively; the subscripts of U_{0|2v-1}, U_{0|v-1} and U_{v|2v-1} denote the subscript of the first and last element of the first column in the block Hankel matrix; uᵥ is measured input vector at time instant v; the output block Hankel matrices Y_{0|2v-1} are generated in a similar way;

(2) Calculate oblique projections Oᵥ as follows

$${O}_{v} = {Y}_{v \vert 2 v - 1} / {U}_{v \vert 2 v - 1} [ \begin{matrix}{U}_{0 \vert v - 1} \\ {Y}_{0 \vert v - 1}\end{matrix} ]$$

(3) Make singular value decomposition for oblique projections;

$${W}_{1} {O}_{v} {W}_{2} = [ \begin{matrix}{U}_{1} & {U}_{2}\end{matrix} ] [ \begin{matrix}{S}_{1} & 0 \\ 0 & 0\end{matrix} ] [ \begin{matrix}{V}_{1}^{T} \\ {V}_{2}\end{matrix} ] = {U}_{1} {S}_{1} {V}_{1}^{T}$$

where S₁ is singular value matrix; U₁ and V₁ are unitary matrix; the user-defined weighting matrices W₁ and W₂ are chosen in such a way that W₁ is of full rank and W₂ obeys:

rank([U_{0|v-1}^{T} Y_{0|v-1}^{T}]^{T})=rank([U_{0|v-1}^{T} Y_{0|v-1}^{T}]^{T}·W₂)

(4) The order k ranges from 2 to nₘₐₓ with the order increment of 2; make the number of rows and columns of the singular value matrix S₁ equal to the set calculation order and combined deterministic-stochastic subspace identification algorithm are used to calculate modal parameters, frequency ωᵢ^{(k)}, damping ξᵢ^{(k)}, mode-shapes φᵢ^{(k)} and modal scaling factor Qᵢ^{(k)}, in the k order, where i represents the mode i appearing in the k order;

Step 2: Preliminary elimination using improved stabilization diagram;

(7) Obtain the initial stable modes using classic stabilization diagram method;

(8) Calculate relative scaling factor difference as follows:

$${dQ}_{i , j}^{( k , k + 1 )} = \frac{\vert {Q}_{i}^{( k )} - α {Q}_{j}^{( k + 1 )} \vert}{max ( {Q}_{i}^{( k )} , α {Q}_{j}^{( k + 1 )} )}$$

where dQ_{i,j}^{(k,k+1)} is relative difference of modal scaling factor between mode i at the calculation orders k and mode j at the calculation orders k+1; and α is the adjustment coefficient of scaling factor,

$$α = {( \frac{{‖ {φ}_{i}^{( k )} ‖}_{2}}{{‖ {φ}_{j}^{( k + 1 )} ‖}_{2}} )}^{2}$$

where ∥•∥₂ denotes the 2 norm of the vector;

Add the relative scaling factor difference threshold to the traditional tolerance limits as a new modal indicator of the classical stabilization diagram to make the stabilization diagram cleaner; set a scaling factor tolerance limit e_{Q}=0.05; the corresponding mode are stable if the relative scaling factor difference meet the scaling factor tolerance limit;

dQ_{i,j}^{(k,k+1)}≤e_{Q}

Select the stable axis according to the distribution of stable poles in the improved stabilization diagram;

Step 3: Further elimination using frequency domain similarity index;

(9) Calculate the SFSI using the single-order FRF and the measured FRF near the natural frequency to distinguish the wrong stable axis;

$$S F S {I}_{k , i} = \frac{{A}_{k , i}^{s} ⋂ {A}_{k , i}^{m}}{{A}_{k , i}^{s} ⋃ {A}_{k , i}^{m}}$$

where •₁∩•₂ denotes the intersection of area •₁ and area •₂; •₁∪•₂ denotes the union of area •₁ and area •₂; the superscript s and m of A denotes the integral area of the single-order FRF and the measured FRF, respectively; and the subscript of SFSI and A denote that the single mode contribution index and integral area are calculated corresponding to the mode i in the order k; the SFSI value of wrong stable axis will be significantly higher than the SFSI value of correct stable axis; and measured FRF can be calculated directly from the data of input and output by the H₁ method; the single-order FRF are calculate as follows:

$${H}_{1 r}^{pq} ( ω ) = - {ω}^{2} ( \frac{{Q}_{r} {φ}_{r}^{p} {φ}_{r}^{qT}}{j ω - {λ}_{r}} + \frac{{\overline{Q}}_{r} {\overline{φ}}_{r}^{p} {φ}_{r}^{qH}}{j ω - {\overline{λ}}_{r}} )$$

where H₁ᵣ^{pq} is the FRF of output point p and input point q with first r modes; ω is the frequency value of spectral line; j=\sqrt{−1}; Qᵣ is the modal scaling factor of mode r; and φᵣ^{p} is the p^{th} element of the modal shape vector φᵣ; •̅ denotes complex conjugate and •^{H} denotes Hermitian transpose; λᵣ is the r^{th} pole of the system;

λᵣ=−ξᵣωᵣ+jωᵣ\sqrt{1−ξᵣ²}

where ξᵣ² is the square of the damping ratio of mode r;

(10) Calculate frequency domain similarity index MFSI of the modes on each selected stable axis as follows:

$${MFSI}_{k , i} = \frac{{A}_{k , i}^{l} ⋃ {A}_{k , i}^{m}}{{A}_{k , i}^{l} ⋂ {A}_{k , i}^{m}}$$

where the superscript l of A denotes the integral area of the lower-order superposition FRF; the lower-order superposition FRF are calculate as follows:

$${H}_{r}^{pq} ( ω ) = {\sum }_{i = 1}^{r} - {ω}^{2} ( \frac{{Q}_{i} {φ}_{i}^{p} {φ}_{i}^{qT}}{j ω - {λ}_{i}} + \frac{{\overline{Q}}_{i} {\overline{φ}}_{i}^{p} {φ}_{i}^{qH}}{j ω - {\overline{λ}}_{i}} )$$

Select the parameters with the index closest to 1 as the physical mode;

Step 4: Obtain the flexibility;

(11) Calculate the flexibility using the modal parameters obtained by proposed method:

$$f = {\sum }_{r = 1}^{{n}_{x}} ( \frac{{Q}_{r} {φ}_{r} {φ}_{r}^{T}}{- {λ}_{r}} + \frac{{\overline{Q}}_{r} {\overline{φ}}_{r} {φ}_{r}^{H}}{- {\overline{λ}}_{r}} )$$

where nₓ is the structural modal order.

The advantage of the invention is that a clearer stabilization diagram can be obtained and improving the stable axis selection process with input and output data. And select the mode that closest to the physical mode of each stable axis. The obtained accurate modal parameters are useful to identify the accurate structural flexibility.

### DESCRIPTION OF DRAWINGS

FIG. 1 is the flow chart of the proposed method; FIG. 2 is the predicted deflection of the beam when each node is applied a 10 kN load.

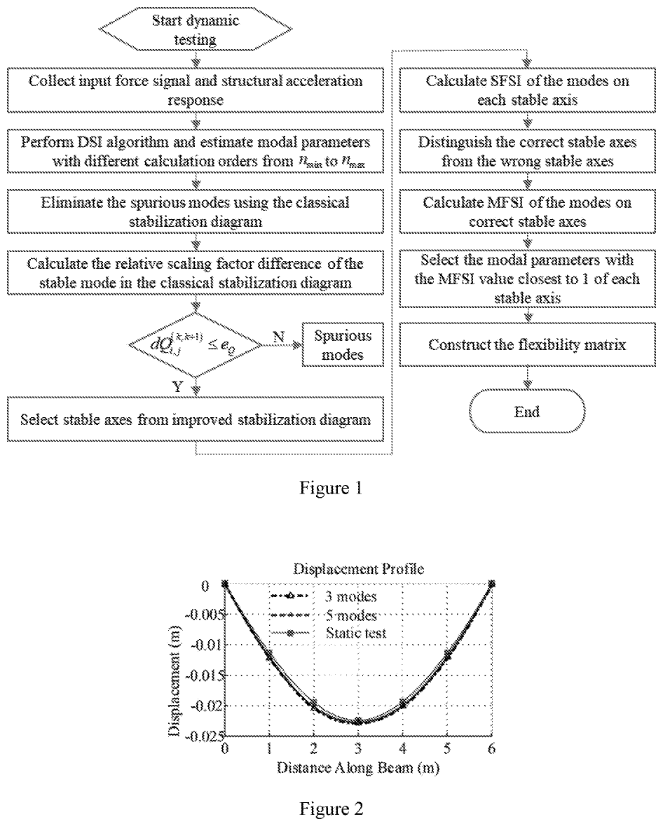

### DETAILED DESCRIPTION

The present invention is further described below in combination with the technical solution.

The numerical example of 5 degree-of-freedom lumped mass model is employed. The length of the simply supported beam is 6 m. The mass lumped to each node is selected as 36.4 kg and the masses are equally spaced on the beam. The flexural rigidity of the beam is 7.3542×10⁶ N·m². The Rayleigh damping ratios of first mode and last mode are 5%. Multiple hammering is applied to node 5. And the responses of five nodes were simulated using the Newmark-β method. The impacting forces and simulated structural accelerations are contaminated with 20% noise and the twenty percent means the standard deviation of the noise is 20% of that of the simulated data.

The procedures are described as follows:

(1) Collect the structural acceleration response from node 1 to node 5 and the input force signal at the node 5. And built Hankel matrices U_{0|2v-1} and Y_{0|2v-1} using input and output data.

(2) Calculate oblique projections Oᵥ using Hankel matrices U_{0|2v-1} and Y_{0|2v-1}. And make singular value decomposition for oblique projections.

$${W}_{1} {O}_{v} {W}_{2} = [ \begin{matrix}{U}_{1} & {U}_{2}\end{matrix} ] [ \begin{matrix}{S}_{1} & 0 \\ 0 & 0\end{matrix} ] [ \begin{matrix}{V}_{1}^{T} \\ {V}_{2}\end{matrix} ] = {U}_{1} {S}_{1} {V}_{1}^{T}$$

where S₁ is singular value matrix; U₁ and V₁ are unitary matrix.

(3) The initial calculation order is set to 2 (k=2). Make the number of rows and columns of the singular value matrix S₁ equal to the set order. Then frequency ωᵢ^{(k)}, damping ξᵢ^{(k)}, mode-shapes φᵢ^{(k)} and modal scaling factor Qᵢ^{(k)} are obtained by combined deterministic-stochastic subspace identification algorithm, respectively.

(4) Repeat step (3) with the order k=k+2 until k=nₘₐₓ (nₘₐₓ=150), modes in different orders are calculated.

(5) Calculate the differences of modal parameters (dω_{i,j}^{(k,k+1)}, dξ_{i,j}^{(k,k+1)} and MAC_{i,j}^{(k,k+1)}) between adjacent orders. And select the stable poles that meet the corresponding threshold limit (e_{ω}=0.05, e_{ξ}=0.2 and e_{MAC}=0.05).

(6) Calculate relative scaling factor difference dQ_{i,j}^{(k,k+1)}. Select the mode that meet the scaling factor tolerance limit (e_{Q}=0.05) as the new stable mode.

(7) Calculate the SFSI using the integral area of the single-order FRF and the measured. FRF. Distinguish the wrong stable axis based on the significant difference between the mean value of SFSI of the modes on the correct stable axis and the mean value of SFSI of the modes on the wrong stable axis.

(8) Calculate the similarity index MFSI using the integral area of the lower-order superposition FRF and the measured FRF.

(9) Select the parameters of each stable axis with the MFSI closest to 1 as the physical mode and the obtained frequency and damping ratio of each mode are as follows: f₁=19.49 Hz, f₂=78.35 Hz, f₃=175.23 Hz, f₄=303.50 Hz, f₅=434.10 Hz; ξ₁=5.0%, ξ₂=2.0%, ξ₃=2.5%, ξ₄=3.6%, ξ₅=5.0%.

(10) Construct the flexibility matrix using obtained modal parameters.

1. A physical mode exaction method for the flexibility identification of engineering structures, comprising the following steps:
step 1: collect input and output data and calculate modal parameters of different orders;
(1) built the Hankel matrix, and the measured inputs are grouped into the following block Hankel matrix,
$${U}_{0 \vert 2 v - 1} = [ \begin{matrix}{u}_{0} & {u}_{1} & {u}_{2} & … & {u}_{w - 1} \\ {u}_{1} & {u}_{2} & {u}_{3} & … & {u}_{w} \\ … & … & … & … & … \\ {u}_{v - 1} & {u}_{v} & {u}_{v + 1} & … & {u}_{v + w - 2} \\ {u}_{v} & {u}_{v + 1} & {u}_{v + 2} & … & {u}_{v + w - 1} \\ {u}_{v + 1} & {u}_{v + 2} & {u}_{v + 3} & … & {u}_{v + w} \\ … & … & … & … & … \\ {u}_{2 v - 1} & {u}_{2 v} & {u}_{2 v + 1} & … & {u}_{2 v + w - 2}\end{matrix} ] = [ \begin{matrix}{U}_{0 \vert v - 1} \\ {U}_{v \vert 2 v - 1}\end{matrix} ]$$
where U_{0|v-1} and U_{v|2v-1} is the upper and lower parts of the matrix U_{o|2v-1}, respectively; the subscripts of U_{0|2v-1}, U_{0|v-1} and U_{v|2v-1} denote the subscript of the first and last element of the first column in the block Hankel matrix; uᵥ is measured input vector at time instant v; the output block Hankel matrices Y_{0|2v-1} are generated in a similar way;
(2) calculate oblique projections Oᵥ as follows
$${O}_{v} = {Y}_{v \vert 2 v - 1} / {U}_{v \vert 2 v - 1} [ \begin{matrix}{U}_{0 \vert v - 1} \\ {Y}_{0 \vert v - 1}\end{matrix} ]$$
(3) make singular value decomposition for oblique projections;
$${W}_{1} {O}_{v} {W}_{2} = [ \begin{matrix}{U}_{1} & {U}_{2}\end{matrix} ] [ \begin{matrix}{S}_{1} & 0 \\ 0 & 0\end{matrix} ] [ \begin{matrix}{V}_{1}^{T} \\ {V}_{2}\end{matrix} ] = {U}_{1} {S}_{1} {V}_{1}^{T}$$
where S₁ is singular value matrix; U₁ and V₁ are unitary matrix; the user-defined weighting matrices W₁ and W₂ are chosen in such a way that W₁ is of full rank and W₂ obeys:
rank([U_{0|v-1}^{T} Y_{0|v-1}^{T}]^{T})=rank([U_{0|v-1}^{T} Y_{0|v-1}^{T}]^{T}·W₂)
(4) the order k ranges from 2 to nₘₐₓ with the order increment of 2; make the number of rows and columns of the singular value matrix S₁ equal to the set calculation order and combined deterministic-stochastic subspace identification algorithm are used to calculate modal parameters, frequency ωᵢ^{(k)}, damping ξᵢ^{(k)}, mode-shapes φᵢ^{(k)} and modal scaling factor Qᵢ^{(k)}, in the k order, where i represents the mode i appearing in the k order;
step 2: preliminary elimination using improved stabilization diagram;
(7) obtain the initial stable modes using classic stabilization diagram method;
(8) calculate relative scaling factor difference as follows:
$${dQ}_{i , j}^{( k , k + 1 )} = \frac{\vert {Q}_{i}^{( k )} - α {Q}_{j}^{( k + 1 )} \vert}{max ( {Q}_{i}^{( k )} , α {Q}_{j}^{( k + 1 )} )}$$
where dQ_{i,j}^{(k,k+1)} is relative difference of modal scaling factor between mode i at the calculation orders k and mode j at the calculation orders k+1; and α is the adjustment coefficient of scaling factor,
$$α = {( \frac{{‖ {φ}_{i}^{( k )} ‖}_{2}}{{‖ {φ}_{i}^{( k + 1 )} ‖}_{2}} )}^{2}$$
where ∥•∥₂ denotes the 2 norm of the vector;
add the relative scaling factor difference threshold to the traditional tolerance limits as a new modal indicator of the classical stabilization diagram to make the stabilization diagram cleaner; set a scaling factor tolerance limit e_{Q}=0.05; the corresponding mode are stable if the relative scaling factor difference meet the scaling factor tolerance limit;
dQ_{i,j}^{(k,k+1)}≤e_{Q}
select the stable axis according to the distribution of stable poles in the improved stabilization diagram;
step 3: further elimination using frequency domain similarity index;
(9) calculate the SFSI using the single-order FRF and the measured FRF near the natural frequency to distinguish the wrong stable axis;
$${SFSI}_{k , i} = \frac{{A}_{k , i}^{s} ⋃ {A}_{k , i}^{m}}{{A}_{k , i}^{s} ⋂ {A}_{k , i}^{m}}$$
where •₁∩•₂ denotes the intersection of area •₁ and area •₂; •₁∪•₂ denotes the union of area •₁ and area •₂; the superscript s and m of A denotes the integral area of the single-order FRF and the measured FRF, respectively; and the subscript of SFSI and A denote that the single mode contribution index and integral area are calculated corresponding to the mode i in the order k; the SFSI value of wrong stable axis will be significantly higher than the SFSI value of correct stable axis; and measured FRF can be calculated directly from the data of input and output by the H₁ method; the single-order FRF are calculate as follows:
$${H}_{1 r}^{pq} ( ω ) = - {ω}^{2} ( \frac{{Q}_{r} {φ}_{r}^{p} {φ}_{r}^{qT}}{j ω - {λ}_{r}} + \frac{{\overline{Q}}_{r} {\overline{φ}}_{r}^{p} {φ}_{r}^{qH}}{j ω - {\overline{λ}}_{r}} )$$
where H₁ᵣ^{pq} is the FRF of output point p and input point q with first r modes; ω is the frequency value of spectral line; j=\sqrt{−1}; Qᵣ is the modal scaling factor of mode r; and φᵣ^{p} is the p^{th} element of the modal shape vector φᵣ; •̅ denotes complex conjugate and •^{H} denotes Hermitian transpose; λᵣ is the r^{th} pole of the system;
λᵣ=−ξᵣωᵣ+jωᵣ\sqrt{1−ξᵣ²}
where ξᵣ² is the square of the damping ratio of mode r;
(10) calculate frequency domain similarity index MFSI of the modes on each selected stable axis as follows:
$${MFSI}_{k , i} = \frac{{A}_{k , i}^{l} ⋃ {A}_{k , i}^{m}}{{A}_{k , i}^{l} ⋂ {A}_{k , i}^{m}}$$
where the superscript l of A denotes the integral area of the lower-order superposition FRF; the lower-order superposition FRF are calculate as follows:
$${H}_{r}^{pq} ( ω ) = {\sum }_{i = 1}^{r} - {ω}^{2} ( \frac{{Q}_{i} {φ}_{i}^{p} {φ}_{i}^{qT}}{j ω - {λ}_{i}} + \frac{{\overline{Q}}_{i} {\overline{φ}}_{i}^{p} {φ}_{i}^{qH}}{j ω - {\overline{λ}}_{i}} )$$
select the parameters with the index closest to 1 as the physical mode;
step 4: obtain the flexibility;
(1 1) calculate the flexibility using the modal parameters obtained by proposed method;
$$f = {\sum }_{r = 1}^{{n}_{x}} ( \frac{{Q}_{r} {φ}_{r} {φ}_{r}^{T}}{- {λ}_{r}} + \frac{{\overline{Q}}_{r} {\overline{φ}}_{r} {φ}_{r}^{H}}{- {\overline{λ}}_{r}} )$$
where nₓ is the structural modal order.
